(19) United States
(12) Patent Application Publication
(10) Pub. No.: US 2002/0118661 A1
(43) Pub. Date: Aug. 29, 2002

(54) Method of optimizing random access performance in a mobile communications network using dynamically controlled persistence techniques

(76) Inventor: Daniel Voce, Germantown, MD (US)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/742,093

(22) Filed: Dec. 22, 2000

(51) Int. Cl. H04J 3/00

(52) U.S. Cl. 370/337; 370/439; 370/447; 370/461; 370/462

(57) ABSTRACT

An apparatus and method for optimizing multiple access satellite and terrestrial mobile communications network performance using random access or multiple access protocols such as frequency division multiple access (FDMA), random access, code division multiple access (CDMA), or optimally, time division multiple access (TDMA) protocols. Performance is optimized through the use of persistence algorithms in congestion control methods for random access channels in such a network, whereby mobile terminal participation is eliminated from the congestion control procedure. In one aspect, a fixed network dynamically directs the operation of a mobile terminal-based persistence algorithm using only locally derived information which is directly transformed into an accurate estimate of random access channel throughput.

### BACKGROUND DESCRIPTION OF THE INVENTION

1. Field of the Invention

The present invention relates to a method for optimizing the performance of multiple access satellite and terrestrial mobile communications networks using random access or multiple access protocols. Specifically, the present invention is directed to congestion control methods for random access channels in such a network, where persistence algorithms are utilized. While various multiple access schemes, such as frequency division multiple access (FDMA), time division multiple access (TDMA), random access or code division multiple access (CDMA) can be used, the techniques presented by this invention are best suited for networks configured utilizing a TDMA protocol.

2. Description of the Related Art

One aspect of mobile communications networks has remained unchanged throughout the evolution of such systems, that is the requirement for a mobile terminal to signal its desire to access the network. Whenever a mobile terminal initiates a voice call or data session, the mobile handset (terminal) normally does not have any system resources dedicated to it by which to relay the particular terminal's intention to access the network. In order to overcome this problem, most prior art mobile communications networks employ one or more random access channels that all users (mobile terminals) within a given boundary share. The random aspect refers to the fact that mobile terminals can access a particular channel at almost any point in time. Since the users have no knowledge of each other, it is possible that multiple users could attempt to access a particular channel simultaneously. This attempted simultaneous access by multiple users results in collisions between the access attempts, effectively blocks these users from accessing the network at that instant, and all the users must try again at a later time. Situations such as this reduce the efficiency of the random access channel and result in delay to the user, which can at times be noticeable, particularly as data services emerge in the mobile environment.

For a single multiple access channel or a random access channel, the control of the order in which mobile terminals are allowed to transmit can directly affect the efficiency, delay and perceived level of quality of service (QoS) of the communications network. Multiple access protocols are usually assessed for channel efficiency and access delay. Often, prior art systems trade-off increased access delay to improve channel efficiency, although generally access delay has a greater impact on the perceived level of QoS of the communications network. The present invention increases the efficiency of the random access channel while reducing delay.

For traditional circuit switched calls, the mobile terminal accesses the random access channel during call setup only. This access allows the mobile terminal to receive a dedicated channel used for the traffic portion (voice or data) of the call. Hence, the random access channel is not needed after the initial access. If the performance of the random access channel were degraded, the user would only experience the delay during call setup. During a packet switched call, however, the random access channel is typically utilized much more frequently, both at the beginning of the session and also throughout the traffic portion of the session as the mobile requests more data transfers. By design, dedicated channels are assigned to the mobile users for short periods of time, and only when there is an immediate need to send data to or from the mobile terminal. When the data has been sent, the dedicated channel is normally released. Obtaining another dedicated channel for data transfer requires another access on the random access channel. As the ratio of data traffic (packet switched) to voice traffic (circuit switched) carried by wireless operators continues to increase throughout the next decade, congestion control on the access channel will become an increasingly important issue.

In TDMA based mobile systems, random access channels are almost universally implemented using Slotted ALOHA techniques. Users (mobile terminals) are assumed to be synchronized to the system time of the network, enabling them to send a request (access attempt) to the network on a particular random access channel only at predefined time intervals. These time intervals are normally called time slots. Two users accessing a particular random access channel during the same time slot will result in a collision, and the network may not be able to process either request. A user becomes aware of a collision when a reply has not been received from the network after a suitable waiting period. The user (mobile terminal) can retry accessing the network during a later time slot if a collision occurs. It is well known in the art that the throughput of a standard Slotted ALOHA channel cannot exceed 36%. That is, the ratio of access requests successfully received by the network to the number of available time slots on the channel is no more than 0.36, no matter the amount of traffic offered to the channel. In fact, as the traffic offered to the channel is increased, the throughput actually decreases towards 0%, due to repeated collisions. This instability can create serious problems in the network and effectively block new users from placing calls once the input load to the channel exceeds a certain threshold. This phenomenon is shown in FIG. 1.

Several attempts were made in the past to mitigate the undesirable effects which occur in TDMA based mobile systems with random access channels implemented using Slotted ALOHA techniques. One method of mitigating these effects uses persistence algorithms. Persistence algorithms define the retransmission scheme used by a mobile terminal. Most prior art persistence algorithms center around control of the following two parameters: (1)Maximum Retry Limit, and (2) Retransmission Window Size.

The maximum retry limit parameter defines the maximum number of retransmission attempts that a mobile terminal can make to the random access channel during a particular call or session. The traffic offered to the random access channel includes new access attempts as well as retransmission attempts. By limiting a particular mobile terminal to a finite number of retries (retransmission attempts), contention on the random access channel is reduced since the retransmission traffic is reduced.

The retransmission window size parameter defines the maximum number of time slots that a mobile terminal may wait between two successive retransmissions. Normally, the mobile terminal chooses a random number of time slots (backoff) to wait until the next retransmission. This random backoff must not exceed the specified window size. Increasing the retransmission window size and the random backoff reduces the chances that two mobiles will repeatedly collide. The probability of a repeated collision is thus reduced when the retransmission window is increased.

Mobile network specifications such as GSM (for example, ETSI GTS GSM 01.02 V5.0.0) specify a range of values that these parameters can assume. However, the specifications do not specify particular settings for these parameters. Specific settings are usually left up to the equipment vendor and/or service operator. The following are a few examples of some known methods for controlling these parameters. These examples are by no means exhaustive or comprehensive, but are merely illustrative of prior art directly related to this invention.

A method for dividing a shared uplink channel into (1) data slots for transmission of actual data, and (2) mini-slots for contention access to the data slots is described in U.S. Pat. No. 5,896,385 to Achilleoudis (“Achilleoudis”). In Achilleoudis a congestion control mechanism is implemented in the base station of a mobile communications system, which monitors the number of received requests on the mini-slots relative to a predetermined threshold. If the threshold is exceeded, data slots are converted to mini-slots to improve performance.

A method for controlling the retransmission window only using feedback from mobile terminals is described in U.S. Pat. No. 5,434,847 to Kou. In Kou, the mobile terminals include a retry count into each access burst to the network (base station), and the base station uses the retry count to gauge the amount of traffic on the random access channel. The retransmission window size is adjusted accordingly. A very similar method and system is described in U.S. Pat. No. 5,490,144 to Tran et al.

U.S. Pat. No. 5,276,911 to Levine et al., describes a method by which an access request count is included in each received request on an access channel. This can be done with or without a mobile terminal input. The access request count is compared to a predetermined threshold in order to determine whether congestion is present on the channel, and appropriate action is taken if necessary. This action may consist of adding additional uplink channels, increasing a range of random access intervals available to the mobile terminals, and/or denying further access to the mobile terminals.

While other prior art methods for congestion control monitor the throughput rate, the present invention monitors a rate of collisions on the random access channel (“RACH”). A low throughput value can occur either because there is very little traffic on the network, or because there is a very large amount of traffic on the RACH and collisions on the RACH are degrading the channel throughput. Put simply, up until the present invention, it has been necessary to determine which scenario was present on the random access channel in order to implement congestion control effectively. This required that the prior art networks used additional means, such as mobile terminal participation, to determine which scenario was occurring at any given time.

### SUMMARY OF THE PRESENT INVENTION

In the aforementioned prior art, participation by the mobile terminal is required in order to control congestion on the random access channel. Input from the mobile terminal allows the base station to control the persistence algorithm parameters dynamically.

Generally, the best practice dictates that where an algorithm can be performed with nearly equal results in both a fixed network (base station) and a mobile terminal, the algorithm is implemented in the fixed network. This is because there are potentially thousands to perhaps millions of mobile terminals in a given communications network, but there are comparatively few components on the fixed side of the network. Should the algorithm require enhancements in the future, updating all of these mobile terminals is a practically impossible task, and would require great inconvenience to the subscribers. On the other hand, updating the software/firmware on the fixed side of the network is relatively inexpensive and can be accomplished without any burden placed on the end users. The system operator has complete control over the operations of these fixed network components. A second concern with mobile terminal participation in congestion control is the restricted bandwidth on the random access channels. Typically, a random access burst contains only a few bits of information due to the large guard times required. It is not always easy to allocate a bit or two from this burst for congestion control purposes.

An object of the present invention is the elimination of the mobile terminal participation in the congestion control procedure for the random access channel. In one aspect of the present invention, the fixed network dynamically directs the operation of a mobile terminal-based persistence algorithm using only information that it derives locally. This information is directly transformed into an accurate estimate of random access channel throughput.

A second object of the invention is to dynamically vary the Maximum Retry Limit (“MRL”) as opposed to the Retransmission Window Size (“RWS”). This is because the MRL has a greater effect on the overall random access channel throughput than RWS. Additionally, dynamic control of the MRL shortens the delay experienced by the users.

A third object of the invention is to produce an adaptive congestion control algorithm useful in both satellite communications systems and terrestrial communications systems.

### BRIEF DESCRIPTION OF THE DRAWINGS

FIG. 1 illustrates a throughput rate in relation to an offer traffic rate on a typical random access channel.

FIG. 2 illustrates a communication system according to an aspect of the invention.

FIG. 3 illustrates the congestion control transition matrix for level 1 congestion control.

FIG. 4 illustrates a comparison of communications systems with and without congestion control according to an aspect of the invention.

FIG. 5 illustrates signal blocking according to a level 2 congestion control process.

FIG. 6 illustrates a throughput rate in relation to a collision slot rate on a random access channel according to an aspect of the invention.

FIG. 7 illustrates the burst alignment within a slot of a Slotted ALOHA RACH.

FIG. 8 illustrates the congestion control process according to an aspect of the invention.

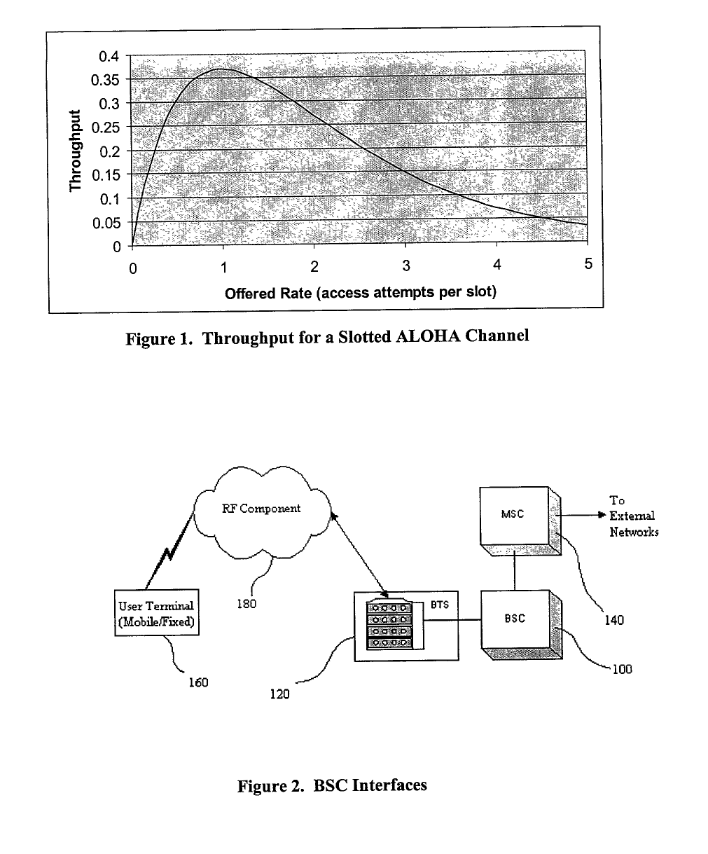

### DETAILED DESCRIPTION OF THE INVENTION

As the traffic offered to the random access channel increases due to, for example, an increase in the number of users, collisions also increase. These collisions in turn lead to an increase in retransmissions, which again tend to increase the traffic offered to the channel. This cycle can lead to instability in the channel, causing the throughput to drop rapidly in a very short period of time.

Low throughput occurs for two reasons. First, there may be few users requiring access to the network, which leads to a low activity factor on the access channel. This is not an undesirable situation to the network, as it requires no action from the network. Secondly, there may be many users requiring access to the random access channel, leading to the unstable situation described above. This is an undesirable situation requiring immediate corrective action by the network. However, the network cannot distinguish between these two opposing situations merely by observing the throughput rate. Thus a different parameter is required for measuring network congestion.

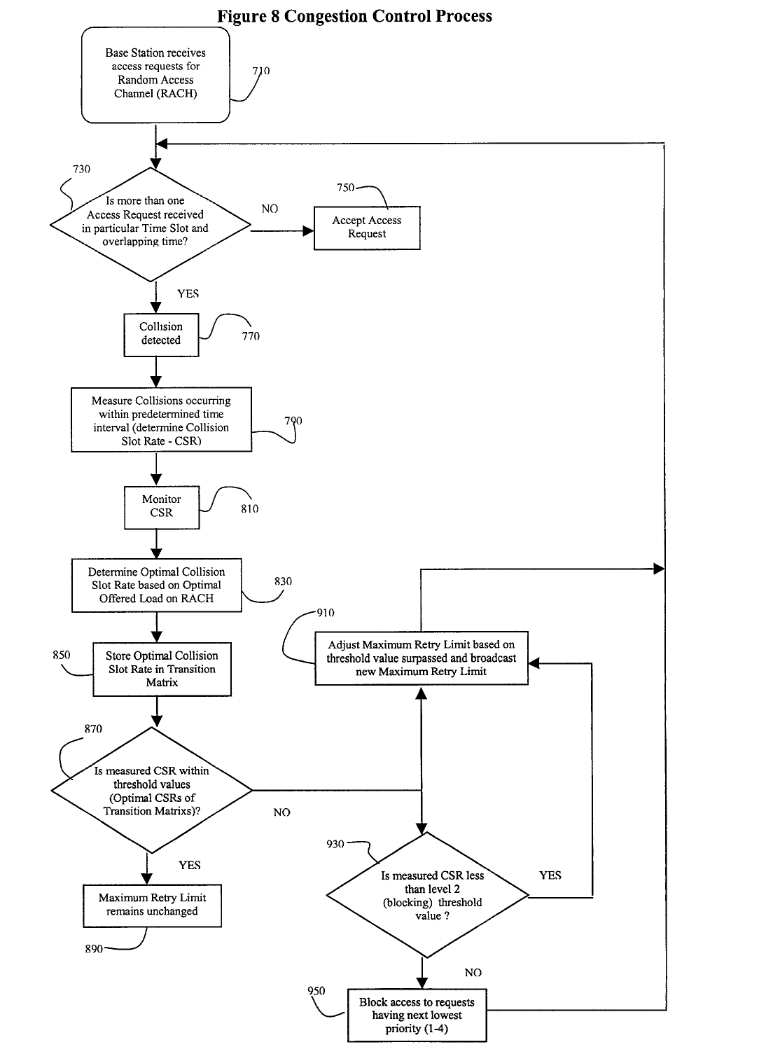

Collision slot rate (CSR) is useful parameter for such congestion control purposes. In the present invention the collision slot rate is utilized to maximize throughput. With reference to FIG. 7 illustrating the alignment of access requests (burst transmissions) from a user terminal to a slot 50 within a slotted ALOHA channel, the CSR is a measure of the rate at which collision slots occur, a collision slot being defined as a slot in which at least one collision has occurred. A slot is a collision slot if and only if at least two bursts were transmitted within the slot and at least two of the transmitted bursts overlap in time. There is a strong inverse correlation between the offered traffic rate and the collision slot rate. Generally, a high collision slot rate implies a high offered traffic rate. Conversely, a low collision slot rate implies a low offered traffic rate. Thus, the network can make realistic assumptions concerning the traffic offered to the random access channel and the realized throughput by observing the collision slot rate in real time. The present invention uses CSR in its congestion control method, as seen in FIG. 8.

On the other hand, prior art methods for congestion control monitored the throughput “S” instead of CSR. As set out above, a low value of S can occur either because there is little traffic on the network, or because there is a large volume of traffic on the RACH and collisions are degrading the throughput. Thus, it has been necessary to determine which situation is present on the RACH in order to implement congestion control effectively. Since it is known that S is maximum when the offered rate “G” is G=1, algorithms have been developed to extract the offered rate G from the measured throughput value S. Then, prior art communication systems would attempt to maintain the RACH at or near an offered rate G=1 whenever possible. Thus, it is clear that there are two values of G that correspond to a given value S, and the prior art networks require additional means (such as mobile participation) to determine which value of G is applicable. This determination is subject to some error, and the elimination of this determination in the present congestion control method has a distinct advantage. CSR is the only parameter needed to determine how the congestion control algorithm should proceed. Furthermore, CSR can be readily and accurately measured at a communication network base station.

The configuration of the relevant portions of a network that would implement the present invention is shown in FIG. 2. The congestion control process is illustrated in FIG. 8. The Base Station Controller (BSC) 100 communicates with the Base Transceiver Station (BTS) 120 and Mobile Switching Center (MSC) 140 to enable communications between mobile User Terminals (UTs) 160 and other networks. The RF component 180 shown in this figure consists of an RF transmitter at the BTS either communicating directly with the UTs (as in cellular networks) or with a spacecraft (as in satellite networks).

Within the BTS, the channel units (CUs) modulate and demodulate transmissions to and from the UTs. With reference to FIG. 8, when multiple UTs transmit during the same time slot of the random access channel (RACH), the receiving CU at the base station detects a collision (710). Broadly speaking, the CU detects a transmission has occurred by detecting the presence of energy on the channel above a predefined threshold—a more detailed explanation of this process is beyond the scope of this disclosure. The CU detects a collision when it is unable to decode the information from the detected transmitted on the RACH. This event is an indication to the CU that a collision has occurred (730, 770).

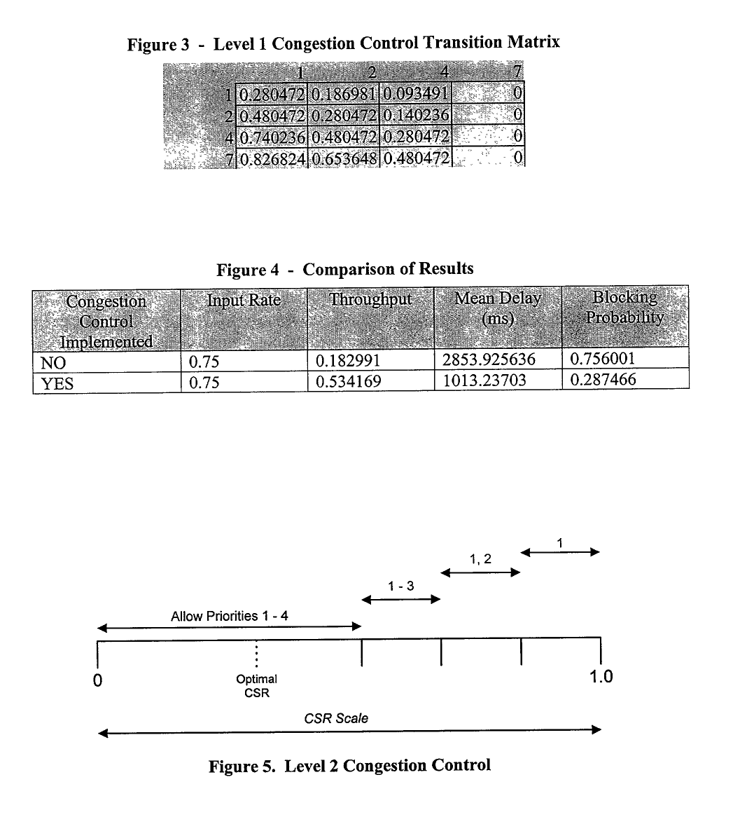

One aspect of the inventive congestion control method employs two levels of control. The first level of control is implemented in part by the receiving CUs as they collect information regarding the collision slot rate during a predetermined interval (790). The duration of this interval depends on the propagation delay of the network and is set roughly equal to twice the round trip delay. For terrestrial cellular networks, this value is approximately ½ ms, whereas for geostationary satellite networks, this value is approximately 1 second. The measured collision slot rate is fed back to the congestion control software of the BSC, which monitors this rate for potential traffic overload on the RACH (810). The BSC compares the collision slot rate to a threshold value (870, FIG. 8) based on the current Maximum Retry Limit (MRL) and, using hysteresis, adjusts the MRL that is broadcast to the UTs accordingly (910). A transition matrix is used to determine when and how the BSC should adjust the MRL (830, 850, 870). An example is given in FIG. 3.

The rows of FIG. 3 represent the current retry limit, and the columns represent the new retry limit. The values within the matrix represent a predetermined CSR. For example, if the current retry limit is 7 (last row), the BSC should not change the retry limit if the CSR is less than 0.480472. If the CSR is between 0.480472 and 0.653648, the retry limit should be changed to 4. The values of the table are determined from formulas based on the optimal CSR for the cell. The optimal CSR is discussed in more detail below.

Dynamically adjusting the MRL using hysteresis to avoid rapid fluctuations dramatically improves the performance of the random access channel. Simulation and analysis show that under certain heavy loads, throughput is more than doubled. Moreover, improved channel conditions decrease access delays by more than half. The results shown in FIG. 4 are indicative of the type of improvement that can be expected using the dynamic congestion control method described herein. This simulation, shown in FIG. 4, of a random access channel in a geosynchronous satellite communications system was developed based on the GMSS standard (Geostationary Orbit Satellite Standard—a standard based on GSM and developed by AceS (Asia Cellular Satellite) and EAST (Euro-African Satellite Telecommunications)) used in the ACeS system and the random access approach defined for GSM's packet data extension GPRS (General Packet Radio Service). A summary of the results are shown in FIG. 4. Note that the improved throughput exceeds the theoretical maximum of 36% mentioned previously due to the large slots used in the GMSS standard. In systems based on this standard, it is possible to receive multiple, non-colliding, bursts within a single slot. This is not the case for the standard Slotted ALOHA protocol.

While these results are very encouraging and indicate the effectiveness of the method described herein, dynamic control of the retry limit nonetheless has its limitations. Occasionally, the amount of traffic input to the channel is too great to be effectively controlled through dynamic control of the MRL. In this case, the heavy traffic saturates the channel and even a severe limitation on the number of allowable retries may not be enough to increase throughput. It is at this point that the network should employ more extreme measures for controlling the congestion. Under these conditions, the BSC implements these measures using the second level of control alluded to. In this second level of control, the CSRs are collected over a longer period of time than the level 1 measurement interval, perhaps 6-8 times longer. If the average of the measurements exceed a level 2 threshold value, the BSC enacts blocking based on traffic priority. This reduces traffic to the access channel at its source, and is maintained until a point is reached where throughput has recovered sufficiently. This concept is illustrated in FIG. 5.

With reference to FIGS. 5 and 8, an example of how the CSR may be used for priority blocking can be explained. In GPRS, there are 4 traffic priorities that are defined, with priority 1 representing the highest priority, or most important, data. It can be seen from FIG. 5 that if the CSR is below or near optimal, all traffic is allowed through. Conversely, if the CSR is very high—near 1.0, then only the highest priority traffic is allowed to access the RACH (930, 950, FIG. 8). Level 2 congestion control, when used in this way, allows a saturated channel time to recover, at which point all traffic priorities can again use the channel.

The above-described method requires the use of several user-configurable parameters and thresholds to produce optimal performance on the random access channel. These include: (1) Level 1 Control parameters including—(a) Collision Slot Rate thresholds for transition matrix/matrices, and (b) Hysteresis Control parameters; and (2) Level 2 Control parameters including—(a) Collision Slot Rate thresholds for priority blocking.

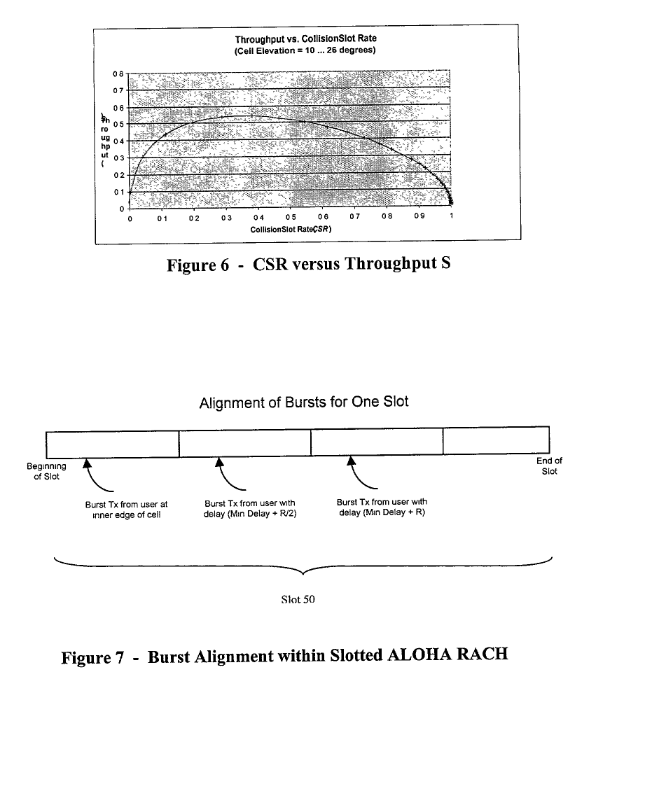

The determination of the optimal values for these parameters is critical to the performance benefit produced. These values can be determined through analysis of the particular network system, and are dependent upon the propagation delays associated with the network in question. By way of example, a brief explanation of the above mentioned GMSS standard is provided. In this standard, a geostationary satellite provides voice and data services to handheld mobile terminals located in spotbeams, or cells. The propagation delay variation within a given cell can be quite large, depending on the size of the cell itself Thus, RACH slots are typically larger than RACH bursts, so that the difference in delays from users within the cell can be accommodated. The network monitors the number of collision slots over a period of time and computes the CSR accordingly. The network need not determine how many collisions occur within a particular slot, only that a collision did or did not occur. One can show mathematically that throughput and the collision slot rate have a relationship similar to the graph shown in FIG. 6.

In FIG. 6, an edge of a hypothetical coverage cell is analyzed for throughput. This optimal performance is achieved at a CSR of approximately 38%. The particular network is programmed to monitor the CSR and adjust the MRL up or down to maintain the CSR at this level (under a level 1 congestion control scheme). Doing so will maximize the throughput on the random access channel.

Throughput Analysis of RACH

The following is a detailed example of the throughput analysis for the random access channel.

Where,

S=throughput, or the mean number of packets successfully received by the base station per timeslot;

G=offered rate, or the mean number of packets offered to the channel per time slot;

P_{c}=probability of a collision for an arbitrary transmission from a user terminal;

R=transmission burst size for the access channel (excluding guard time) in ms, typically less than the length of a timeslot;

d=cell delay variation (max delay to base station−min delay to base station) in ms

In a standard Slotted ALOHA channel, it is well known that the throughput and offered load are related by the equation

S=G(1−P_{c}), (1)

Where

P_{c}=1−e^{-G} (2)

Variations on the Slotted ALOHA channel can also be described by Equation (1) but the collision probability described in Equation (2) may differ with propagation delay as set out above.

Equations (1) and (2) can be used to determine the maximum possible throughput S for a Slotted ALOHA channel simply by optimizing the resulting formula. The maximum possible throughput is 1/e=36.7% and occurs when G=1. The next step is to determine a mechanism by which the network can operate the channel near this maximum throughput. That is, the network should attempt to maintain an offered load of G=1 packets per cell whenever possible.

The throughput is maximized for a CSR=0.38% in this example. This, of course, occurs when the channel is operating at the optimal offered load G mentioned above. What is needed to determine this optimal CSR value, then, is an equation yielding CSR in terms of G. This is given in Equation (3).

$$CSR = 1 - [ {e}^{- G} + G {e}^{- G} + \frac{{G}^{2}}{2 !} {e}^{- G} ( 1 - p A v g ) + \frac{{G}^{3}}{3 !} {{e}^{- G} ( 1 - p A v g )}^{3} + \frac{{G}^{k}}{k !} {{e}^{- G} ( 1 - p A v g )}^{( 1 + 2 + … + k - 1 )} ] \qquad ( 3 )$$

The parameter k in Equation (3) depends upon the size of the timeslot and the delay variation in the cell. Essentially, k is equal to the maximum number of bursts that can theoretically fit into one timeslot for the cell in question. An example of a slot/cell combination admitting at most three non-colliding bursts per slot is shown in FIG. 7.

The value of of k is obtained from the formula:

$$k = ceil ( \frac{d}{\frac{R}{2}} ) \qquad ( 4 )$$

The parameter pAvg represents the average of the average number of users within R/2 ms of a given user within the cell, assuming a uniform distribution of users within the cell (pAvg is an average of averages). For example, in standard terrestrial GSM cellular networks, the value of pAvg is always 1 since the cell delay variation is small relative to the size of a random access transmission burst. That is, for a given GSM user, it is guaranteed that all other users within the same cell have delays to the base station that are within R/2 ms of the given user's delay since the cell sizes are small (e.g. less than 35 km in diameter). In the GMSS standard, pAvg is typically less than 1 since the cell (spot beam) delay variation can be quite large.

Equation (3) is derived where the offered rate G is Poisson distribution and the probability of j bursts not overlapping, given that they were transmitted in the same slot, is (1−pAVg)^{(1+2 . . . +j-1)} when no retransmissions are allowed. This is true because the probability of a given burst coming from a particular terminal is the same regardless of the particular user terminal when there are no retransmissions.

Using the optimal value of G found from optimizing the combination of Equations (1) and (2) for Slotted ALOHA (or by techniques for the GMSS standard), Equation (3) provides the appropriate CSR for the particular channel. The base station can directly measure the CSR (a distinct advantage of this technique) and modify the maximum retry value to lower or raise the CSR to the appropriate level.

A transition matrix is used by the base station to control the maximum retries allowable by the users within the cell. The values of this transition matrix are determined from the optimal CSR found using the mathematical techniques used above. In addition the transition matrix values may be modified or updated based on operator configuration or self-learning techniques. The transition matrix is used to determine when and how the BSC should adjust the maximum retry limit. An example is given in FIG. 3.

The transition table of FIG. 3 was initialized using the algorithm given below, where CSR_THRESHOLD refers to the optimal CSR for the cell as determined above.

TransitionMatrix[RETRY1][RETRY1] = CSR_THRESHOLD − 0.1;
TransitionMatrix[RETRY1][RETRY2] = 2.0/3.0*(CSR_THRESHOLD − 0.1);
TransitionMatrix[RETRY1][RETRY4] = 1.0/3.0*(CSR_THRESHOLD − 0.1);
TransitionMatrix[RETRY1][RETRY7] = 0.0;
TransitionMatrix[RETRY2][RETRY1] = CSR_THRESHOLD + 0.1;
TransitionMatrix[RETRY2][RETRY2] = CSR_THRESHOLD − 0.1;
TransitionMatrix[RETRY2][RETRY4] = 1.0/2.0*(CSR_THRESHOLD − 0.1);
TransitionMatrix[RETRY2][RETRY7] = 0.0;
TransitionMatrix[RETRY4][RETRY1] = 1.0 − (1.0 − (CSR_THRESHOLD +
0.1))/2.0;
TransitionMatrix[RETRY4][RETRY2] = CSR_THRESHOLD + 0.1;
TransitionMatrix[RETRY4][RETRY4] = CSR_THRESHOLD − 0.1;
TransitionMatrix[RETRY4][RETRY7] = 0;
TransitionMatrix[RETRY7][RETRY1] = 1.0 − 1.0/3.0*(1.0 − (CSR_THRESHOLD = 0.1));
TransitionMatrix[RETRY7][RETRY2] = 1.0 − 2.0/3.0*(1.0 − (CSR_THRESHOLD = 0.1));
TransitionMatrix[RETRY7][RETRY4] = CSR_THRESHOLD + 0.1;
TransitionMatrix[RETRY7][RETRY7] = 0;

Because it is impossible to predict future uses of wireless networks (e.g. traffic profiles), an adaptable solution is considered. The mathematical analysis described above is based on a Poisson model which may not always best represent the traffic offered to the channel, although it has proven to be an accurate model for random access channels in the past. An adaptable solution can be achieved in several ways.

These include operator configurable parameters using statistics provided from the BSC, and self learning techniques (parameter modification based upon network observation results over a period of days or weeks, considering diurnal variations).

In the first case, a network operator manually configures the parameters controlling the operation of the invention (CSR threshold, etc). To aid in operator decisions, the BSC may compile daily statistics providing a detailed overview of the random access channel performance. The operator can compare these reports against the configuration to determine the effectiveness of the values that are in place.

In the second case, no operator involvement is needed (although it is not prohibited either). The congestion control process within the BSC observes the daily statistics and adjusts the configurable parameters accordingly. Significant intelligence can be built into the congestion control process, allowing for parameter adjustments over specific hours of specific days, if desired.

The method described here is equally applicable to circuit switched networks and packet switched networks, which can be terrestrial based and space based. Congestion control is introduced to improve the efficiency of the channel while increasing the performance as observed by the user in the form of reduced delay. Whereas this is an important consideration in a circuit switched environment, it is even more crucial in a packet switched network.

While the present invention has been described using specific terms and preferred embodiments, such description is for illustrative purposes only, and it is understood that changes and variations may be made by one skilled in the art without deviating from the broad principles and teachings of the present invention which shall be limited solely by the scope of the claims appended hereto.

What is claimed:

1. A system for optimizing random access channel performance in a communication network using dynamically controlled persistence techniques, comprising:
a plurality of user terminals;
a base station for transmitting information to and receiving information from said user terminals, said base station comprising a base station controller and a base transceiver station which further includes a plurality of channel units;
said plurality of user terminals being synchronized with a system time of said communication network and being operative to access the network by transmitting access requests to at least one random access channel of said network during any one of a plurality of predefined time slots, wherein more than one said access request may be received at any one of the predefined time slots at the same time, thereby causing a collision between the access requests and preventing access to the network by the requesting user terminals;
said channel unit of said base transceiver station being operative to detect collisions between the user terminal access requests, measure the number of collisions during a predefined time interval and provide a resulting collision slot rate to said base station controller;
said base station controller being operative to compare the collision slot rate to a threshold value;
said base station controller being operative to adjust a maximum retry limit accordingly, wherein said maximum retry limit is the maximum number of times a particular user terminal of said plurality of user terminals may attempt to access said at least one random access channel during a particular call session;
said base station controller being operative to adjust said maximum retry limit in order to optimize the collision slot rate for a given load on said at least one random access channel, and provide the adjusted maximum retry limit to the base transceiver station; and
said base transceiver station being operative to broadcast the adjusted maximum retry limit to the plurality of user terminals..

2. A system for optimizing random access channel performance in communication network using dynamically controlled persistent techniques, comprising:
a plurality of user terminals;
a base station for transmitting information to and receiving information from said user terminals;
said base station being operative to provide at least one random access channel for receiving access requests from said plurality of user terminals during one of a plurality of predetermined time slots which are synchronized with the user terminals;
said base station being operative to determine when more than one said access request is received during a particular time slot, resulting in a collision between the received access requests;
said base station being operative to measure the number of collisions occurring during a predetermined time interval to determine a collision slot rate;
said base station being operative to compare the determined collision slot rate to a predetermined value; and
said base station being operative to adjust the number of access attempts any one of said plurality of user terminals may make to said at least one random access channel during a particular call session.

3. The system according to claim 2, wherein:
a maximum retry limit represents the maximum number of access attempts to the random access channel a particular user terminal may attempt during a particular call session;
said base station being operative to adjust said maximum retry limit to optimize said collision slot rate for a particular load on said at least one random access channel; and
said base station being operative to broadcast said maximum retry limit to said plurality of user terminals.

4. The system according to claim 3, wherein:
said base station is operative to block the access requests having a predetermined priority when said collision slot rate exceeds a predetermined threshold value.

5. The system according to claim 3, wherein:
said base station further comprises a base station controller and a base transceiver station.

6. The system according to claim 4, wherein said user terminal comprises a mobile cellular terminal.

7. The system according to claim 4, wherein said user terminal comprises a satellite terminal.

8. The system according to claim 5, wherein:
said base transceiver station is operative to determine said collision slot rate and transmit the determined collision slot rate to said base station controller;
said base station controller is operative to compare the determined collision slot rate to a threshold value;
said base station controller is operative to adjust said maximum retry limit to optimize the determined collision slot rate for a particular random access channel load;
said base station controller is operative to provide said adjusted maximum retry limit to said base transceiver station; and
said base transceiver station is operative to broadcast said adjusted maximum retry limit to said plurality of user terminals.

9. The system according to claim 8, wherein:
said base station controller is operative to calculate an optimal collision slot rate at an optimal offered load of said at least one random access channel and store said optimal collision slot rate in a transition matrix; and
said base station is operative to compare the determined collision slot rate to the optimal collision slot rates stored within said transition matrix and adjust the maximum retry limit accordingly.

10. The system according to claim 9, wherein:
the optimal collision slot is calculated in terms an optimal offered load on said at least one random access channel by said base station controller according to an algorithm where:
S=throughput, or the mean number of packets successfully received by the base station per timeslot;
G=offered rate, or the mean number of packets offered to the channel per time slot;
PC=probability of a collision for an arbitrary transmission from a user terminal;
R=transmission burst size for the access channel (excluding guard time) in ms, typically less than the length of a timeslot;
d=cell delay variation (max delay to base station−min delay to base station) in ms;
the throughput and offered load are related by the equation:
S=G(1−P_{c}), (1)
where
P_{c}=1−e^{-G} (2)
where the optimal collision slot rate (CSR) value is determined by an equation yielding CSR in terms of G:
$$CSR = 1 - [ {e}^{- G} + G {e}^{- G} + \frac{{G}^{2}}{2 !} {e}^{- G} \vert {( 1 - p A v g )}^{3} + \frac{{G}^{k}}{k !} {{e}^{- G} ( 1 - p A v g )}^{( 1 + 2 + … + k - 1 )} ]$$
$$and$$
$$k = ceil ( \frac{d}{\frac{R}{2}} ) .$$

11. A base station in a communication network, wherein:
said base station is operative to provide at least one random access channel for receiving network access requests and allowing access to said communication network;
said random access channel includes a plurality of time slots having a predetermined duration;
said base station is operative to determine when more than one said access request is received during a particular one of said plurality of time slots, resulting in a collision between the received access requests;
said base station is operative to measure the number of collisions occurring during a predetermined time interval to determine a collision slot rate; and
said base station is operative to compare the collision slot rate to a predetermined value.

12. A method for optimizing random access performance in a communication network using dynamically controlled persistent techniques comprising the steps of:
providing from a base station at least one random access channel for accessing said communication network;
transmitting from a plurality of user terminals, which are synchronized with a system time of said communication network, access requests to said at least one random access channel during a predefined time slot;
detecting by a channel unit of a base transceiver station of said base station when more than one said access request is received during a particular time slot, resulting in a collision between the received access requests;
measuring by said channel unit the number of collisions occurring during a predetermined time interval and determining a collision slot rate therefrom, and transmitting the collision slot rate to a base station controller of said base station;
comparing at said base station controller said collision slot rate to a threshold value;
adjusting at said base station controller a maximum retry limit accordingly, to optimize the collision slot rate for a particular load on said at least one random access channel, wherein said maximum retry limit represents a maximum number of access attempts to at least one random access channel a particular user terminal of said user terminals may to attempt during a particular call session;
transmitting at said base station controller the adjusted maximum retry limit to said base transceiver station; and
broadcasting from said base transceiver station the adjusted maximum retry limit to said plurality of user terminals.

13. A method for optimizing random access performance in a communication network using dynamically controlled persistent techniques comprising the steps of:
providing from a base station at least one random access channel for accessing said communication network;
transmitting from a plurality of user terminals which are synchronized with a system time of said communication network access requests to said at least one random access channel during one of a plurality of predetermined time slots;
determining at said base station when more than one said access request is received during a particular time slot resulting in a collision between the received access requests;
measuring at said base station the number of collisions occurring during a predetermined time interval to determine a collision slot rate;
comparing at said base station the determined collision slot rate to a threshold value; and
adjusting at said base station the number of access attempts any one of said plurality of user terminals may make to said at least one random access channel during a particular call session.

14. The method according to claim 13, further comprising the steps of:
adjusting at said base station a maximum retry limit to optimize said collision slot rate for a particular load on said at least one random access channel, wherein said maximum retry limit represents the maximum number of access attempts to the random access channel a particular user terminal may attempt during a particular call session; and
broadcasting at said base station said maximum retry limit to said plurality of user terminals.

15. The method according to claim 14, further comprising the step of:
blocking at said base station the access requests having a predetermined priority when said collision slot rate exceeds a predetermined threshold value.

16. The method according to claim 14, wherein:
said base station further comprises a base station controller and a base transceiver station.

17. The method according to claim 16, wherein said user terminal comprises a mobile cellular terminal.

18. The method according to claim 16, wherein said user terminal comprises a satellite terminal.

19. The method according to claim 16, further comprising the steps of:
determining by said base transceiver station said collision slot rate and transmitting said collision slot rate to said base station controller;
comparing at said base station controller said collision slot rate to a threshold value;
adjusting at said base station controller said maximum retry limit, accordingly, to optimize the collision slot rate for a particular random access channel load;
transmitting at said base station controller said adjusted maximum retry limit to said base transceiver station; and
broadcasting from said base transceiver station said adjusted maximum retry limit to said plurality of user terminals.

20. The system method according to claim 19, further comprising the steps of:
calculating at said base station controller an optimal collision slot rate at an optimal offered load of said at least one random access channel;
storing at said base station controller said optimal collision slot rate in a transition matrix;
comparing at said base station controller the determined collision slot rate to the optimal collision slot rates within said transition matrix and adjusting the maximum retry limit accordingly.

21. The method according to claim 20, wherein:
the optimal collision slot is calculated in terms an optimal offered load on said at least one random access channel by said base station controller according to an algorithm where:
S=throughput, or the mean number of packets successfully received by the base station per timeslot;
G=offered rate, or the mean number of packets offered to the channel per time slot;
P_{c}=probability of a collision for an arbitrary transmission from a user terminal;
R=transmission burst size for the access channel (excluding guard time) in ms, typically less than the length of a timeslot;
d=cell delay variation (max delay to base station−min delay to base station) in ms;
the throughput and offered load are related by the equation:
S=G(1−P_{c}) (1)
where
P_{c}=1−e^{-G} (2)
where the optimal collision slot rate (CSR) value is determined by an equation yielding CSR in terms of G:
$$CSR = 1 - [ {e}^{- G} + G {e}^{- G} + \frac{{G}^{2}}{2 !} {e}^{- G} \vert {( 1 - p A v g )}^{3} + \frac{{G}^{k}}{k !} {{e}^{- G} ( 1 - p A v g )}^{( 1 + 2 + … + k - 1 )} ]$$
$$and$$
$$k = ceil ( \frac{d}{\frac{R}{2}} ) .$$

22. A method for communicating between a base station and a plurality of user terminals in a communication network using dynamically controlled persistent techniques comprising the steps of:
providing from at least one random access channel for accessing said communication network;
transmitting from said plurality of user terminals which are synchronized with a system time of said communication network access requests to said at least one random access channel during one of a plurality of predetermined time slots;
determining at said base station when more than one said access request is received during a particular time slot resulting in a collision between the received access requests;
measuring at said base station the number of collisions occurring during a predetermined time interval to determine a collision slot rate;
comparing at said base station said determined collision slot rate to a threshold value; and
adjusting at said base station the number of access attempts any one of said plurality of user terminals may make to said at least one random access channel during a particular call session.

23. The method according to claim 22, further comprising the steps of:
adjusting at a base station controller of said base station a maximum retry limit to optimize said collision slot rate for a particular load on said at least one random access channel, wherein said maximum retry limit represents the maximum number of access attempts to the random access channel a particular user terminal may attempt during a particular call session; and
broadcasting from a base transceiver station of said base station said maximum retry limit to said plurality of user terminals.

24. The method according to claim 23, further comprising the steps of:
determining at said base transceiver station said collision slot rate and transmiting said collision slot rate to said base station controller;
comparing at said base station controller the determined collision slot rate to a threshold value;
adjusting at said base station controller said maximum retry limit accordingly, to optimize the collision slot rate for a particular random access channel load;
transmitting at said base station controller said adjusted maximum retry limit to said base transceiver station; and
broadcasting from said base transceiver station said adjusted maximum retry limit to said plurality of user terminals.

25. The method according to claim 24, further comprising the step of:
blocking at said base station controller the access requests having a predetermined priority when said collision slot rate exceeds a predetermined threshold value.

26. The method according to claim 24, further comprising the steps of:
calculating at said base station controller for an optimal offered load of said at least one random access channel an optimal collision slot rate;
storing at said base station controller said optimal collision slot rate in a transition matrix;
comparing at said base station controller the determined collision slot rate to the optimal collision slot rates within said transition matrix and adjusting the maximum retry limit accordingly.

27. The method according to claim 26, wherein:
the optimal collision slot is calculated in terms an optimal offered load on said at least one random access channel by said base station controller according to an algorithm where:
S=throughput, or the mean number of packets successfully received by the base station per timeslot;
G=offered rate, or the mean number of packets offered to the channel per time slot;
P_{c}=probability of a collision for an arbitrary transmission from a user terminal;
R=transmission burst size for the access channel (excluding guard time) in ms, typically less than the length of a timeslot;
d=cell delay variation (max delay to base station−min delay to base station) in ms;
the throughput and offered load are related by the equation:
S=G(1−P_{c}), (1)
where
P_{c}=1−e^{-G} (2)
where the optimal collision slot rate (CSR) value is determined by an equation yielding CSR in terms of G:
$$CSR = 1 - [ {e}^{- G} + G {e}^{- G} + \frac{{G}^{2}}{2 !} {e}^{- G} \vert {( 1 - p A v g )}^{3} + \frac{{G}^{k}}{k !} {{e}^{- G} ( 1 - p A v g )}^{( 1 + 2 + … + k - 1 )} ]$$
$$and$$
$$k = ceil ( \frac{d}{\frac{R}{2}} ) .$$

28. A computer program product including a computer readable medium containing instructions for optimizing random access channel performance in a communication network using dynamically controlled persistence techniques, said instructions comprising the steps of:
providing from a base station at least one random access channel, including a plurality of time slots having a predetermined duration, for receiving network access requests and allowing access to said communication network;
determining at said base station when more than one said access request is received during a particular one of said plurality of time slots, resulting in a collision between the received access requests;
measuring at said base station the number of collisions occurring during a predetermined time interval to determine a collision slot rate; and
comparing at said base station the determined collision slot rate to a predetermined value.

29. The computer program product according to claim 28, wherein a plurality of user terminals are synchronized with a system time of said communication network and transmit said access requests to said at least one random access channel during one of said plurality of predetermined time slots, said instructions further comprising the step of:
adjusting at said base station the number of access attempts any one of said plurality of user terminals may make to said at least one random access channel during a particular call session.

30. The computer program product according to claim 29, said instructions further comprising the step of:
adjusting at a base station controller of said base station a maximum retry limit to optimize said collision slot rate for a particular load on said at least one random access channel, wherein said maximum retry limit represents the maximum number of access attempts to the random access channel a particular user terminal may attempt during a particular call session.

31. The computer program product according to claim 30, said instructions further comprising the steps of:
determining at a base transceiver station of said base station said collision slot rate and transmiting said collision slot rate to said base station controller;
comparing at said base station controller the determined collision slot rate to a threshold value; and
adjusting at said base station controller said maximum retry limit accordingly, to optimize the collision slot rate for a particular random access channel load.

32. The computer program product according to claim 31, said instructions further comprising the step of:
blocking at said base station controller the access requests having a predetermined priority when said collision slot rate exceeds a predetermined threshold value.

33. The computer program product according to claim 32, said instructions further comprising the steps of:
calculating at said base station controller an optimal collision slot rate at an optimal offered load of said at least one random access channel;
storing at said base station controller said optimal collision slot rate in a transition matrix; and
comparing at said base station controller the determined collision slot rate to the optimal collision slot rates stored within said transition matrix and adjusting the maximum retry limit accordingly.

34. The computer program product according to claim 33, wherein:
the optimal collision slot is calculated in terms an optimal offered load on said at least one random access channel by said base station controller according to an algorithm where:
S=throughput, or the mean number of packets successfully received by the base station per timeslot;
G=offered rate, or the mean number of packets offered to the channel per time slot;
P_{c}=probability of a collision for an arbitrary transmission from a user terminal;
R=transmission burst size for the access channel (excluding guard time) in ms, typically less than the length of a timeslot;
d=cell delay variation (max delay to base station−min delay to base station) in ms;
the throughput and offered load are related by the equation:
S=G(1−P_{c}), (1)
where
P_{c}=1−e^{-G} (2)
where the optimal collision slot rate (CSR) value is determined by an equation yielding CSR in terms of G:
$$CSR = 1 - [ {e}^{- G} + G {e}^{- G} + \frac{{G}^{2}}{2 !} {e}^{- G} \vert {( 1 - p A v g )}^{3} + \frac{{G}^{k}}{k !} {{e}^{- G} ( 1 - p A v g )}^{( 1 + 2 + … + k - 1 )} ]$$
$$and$$
$$k = ceil ( \frac{d}{\frac{R}{2}} ) .$$
